(19) United States
(12) Patent Application Publication
(10) Pub. No.: US 2017/0085027 A1
(43) Pub. Date: Mar. 23, 2017

(54) SELF-ALIGNING ELECTRICAL CONNECTOR ASSEMBLY

(71) Applicant: Amphenol Corporation, Wallingford, CT (US)

(72) Inventors: Braden J. ISHAUG, Boston, MA (US); James R. MESZAROS, Middleboro, MA (US)

(21) Appl. No.: 14/858,352

(22) Filed: Sep. 18, 2015

(51) Int. Cl. H01R 13/62

(52) U.S. Cl. CPC H01R 13/6205

(57) ABSTRACT

An electrical connector assembly that includes a first electrical component having a housing supporting at least one first contact, and including an interface end with a first alignment member. A second electrical component is configured to mate with the first component and has a housing supporting at least one second contact, and includes an interface end with a second alignment member adapted to engage the first alignment member. At least a first magnet is disposed at the interface end of the first component and has a first polarization. At least a second magnet is disposed at the interface end of the second component and has a second polarization that is the opposite of the first polarization. The first and second magnets attract one another to self-align the components such that the alignment members are engaged with one another and the contacts are mated with one another.

### FIELD OF THE INVENTION

The present invention relates to an electrical connector assembly that has self-aligning components for proper mating where the components are also configured to repel each other to prevent improper mating thereof.

### BACKGROUND OF THE INVENTION

Components of conventional electrical connector assemblies can often be difficult to properly mate without several attempts. That is particularly true as components get smaller in size, thereby making them more difficult to see and manipulate, and when such components are situated or located such that one or more of the components is not easily visible (e.g. on the bottom or back of an assembly). It can also be difficult for users with reduced and/or limited dexterity (i.e. elderly, disabled, etc.) or for users in a situation of high stress in which the connection may be critical or life-saving/sustaining. In addition, connectors that do not have a mechanical means to couple are prone to experience momentary discontinuities or signal interruptions due to vibration, shock, or other environmental factors.

Therefore, a need exists for an electrical connector assembly that self-aligns to facilitate proper mating of its components, particularly when blind-mating the components or when the components are small and difficult to manipulate. The need also exists to stabilize the mating interface of the electrical connector to reduce or overcome the effects of vibration and eliminate the possibility of openings or discontinuities during operation or signal transfer.

### SUMMARY OF THE INVENTION

Accordingly, the present invention may provide an electrical connector assembly that includes a first electrical component that has a housing supporting at least one first contact. The housing includes an interface end with a first alignment member. A second electrical component is configured to mate with the first electrical component. The second electrical component has a housing that supports at least one second contact configured to mate with the at least one first contact. The housing includes an interface end with a second alignment member that is adapted to engage the first alignment member. At least a first magnet may be disposed at the interface end of the first electrical component. The first magnet has a first polarization. At least a second magnet may be disposed at the interface end of the second electrical component. The second magnet has a second polarization that is the opposite of the first polarization. The first and second magnets attract one another to self-align the first and second electrical components such that the first and second alignment members are engaged with one another and the first and second contacts are mated with one another.

The present invention may further provide an electrical connector assembly that includes a first electrical component that has a housing that supports at least one first contact. The housing includes an interface end with a first alignment member. A second electrical component is configured to mate with the first electrical component. The second electrical component has a housing that supports at least one second contact configured to mate with the at least one first contact. The housing includes an interface end with a second alignment member that is adapted to engage the first alignment member. A first magnet may be disposed at the interface end of the first electrical component. The first magnet has a first polarization. A second magnet may be disposed at the interface end of the second electrical component. The second magnet has a second polarization that is the opposite of the first polarization. A third magnet may be disposed at the interface end of the first electrical component. The third magnet has a polarization that is the opposite of the first polarization. A fourth magnet may be disposed at the interface end of the second electrical component. The fourth magnet has a polarization that is the opposite of the second polarization. The first and second magnets attract one another and the third and fourth magnets attract one another to self-align the first and second electrical components such that the first and second alignment members are engaged with one another and the first and second contacts are mated with one another. The first and third magnets repel one another and the second and fourth magnets repel one another to prevent engagement of the first and second contacts.

Other objects, advantages and salient features of the invention will become apparent from the following detailed description, which, taken in conjunction with the annexed drawings, discloses a preferred embodiment of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view of an electrical connector assembly according to an exemplary embodiment of the present invention, showing mating components of the assembly properly mated;

FIG. 2 is an exploded perspective view of the electrical connector assembly illustrated in FIG. 1, showing the components exploded from one another;

FIG. 3 is a cross-sectional view of the electrical connector assembly illustrated in FIG. 1, showing the components aligned and properly mated; and

FIG. 4 is a cross-sectional view of the electrical connector assembly similar to FIG. 3, showing the components repelling one another to prevent improper mating.

### DETAILED DESCRIPTION OF THE EXEMPLARY EMBODIMENTS

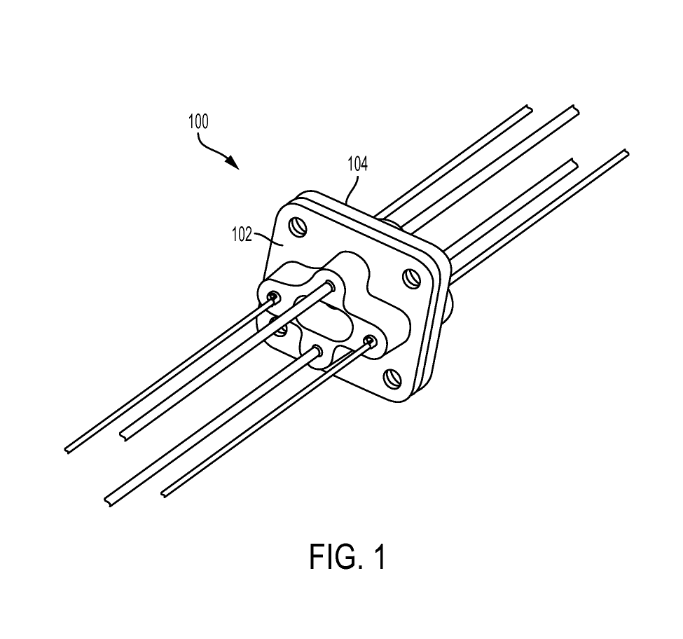

Referring to FIGS. 1-4, the present invention provides an electrical connector assembly 100 that has electrical components 102 and 104, that self-align to facilitate positive and proper electrical and mechanical mating. The components 102 and 104 are also designed to prevent improper mating therebetween, preferably by repelling one another.

The first electrical component 102 may be a plug that is configured to mate with the second electrical component 104, which may be a receptacle. The plug component 102 may terminate a cable, such as a charging cord, monitoring cord, data transfer cord, or a cord mounted to an electrical box or other device, and the like. The receptacle component 104 may be incorporated into any electrical equipment, for example medical equipment, office equipment, computers, hand-held electrical devices, medical or industrial controllers, or patient worn charging and/or monitoring device, and the like.

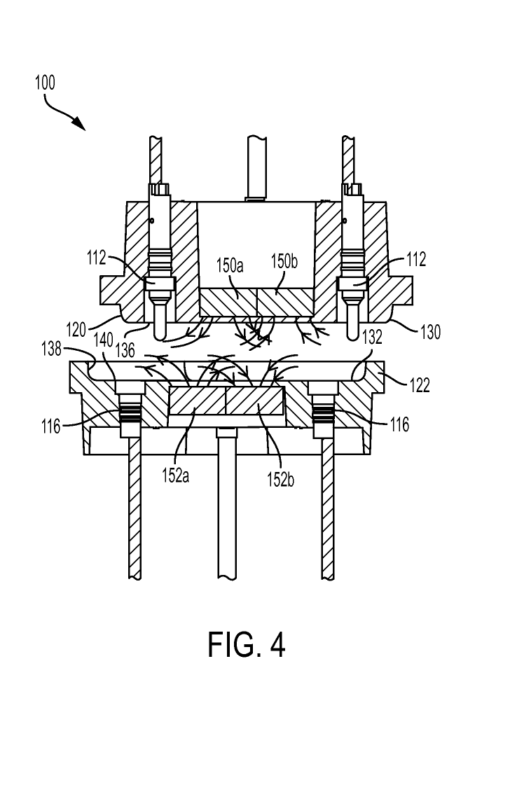

The plug component 102 generally includes a housing 110 that supports one or more contacts 112 (FIGS. 3 and 4), such as a pins. Likewise, the receptacle component 104 includes a housing 114 that supports one or more contacts 116 (FIGS. 3 and 4), such as sockets, configured to mate with the contacts 112 of the plug component 102. The housing 110 of the plug component 102 includes an interface end 120 configured to mate with an interface end 122 of the receptacle component housing 114. The plug component housing 110 includes a cable termination end 124 opposite its interface end 120. Extending between the interface end 122 and the cable termination end 124 of the plug component 102 are one or more cavities 126 for accepting the individual contacts 112. The contacts 112 may be electrically and mechanically coupled to a cable in any known manner.

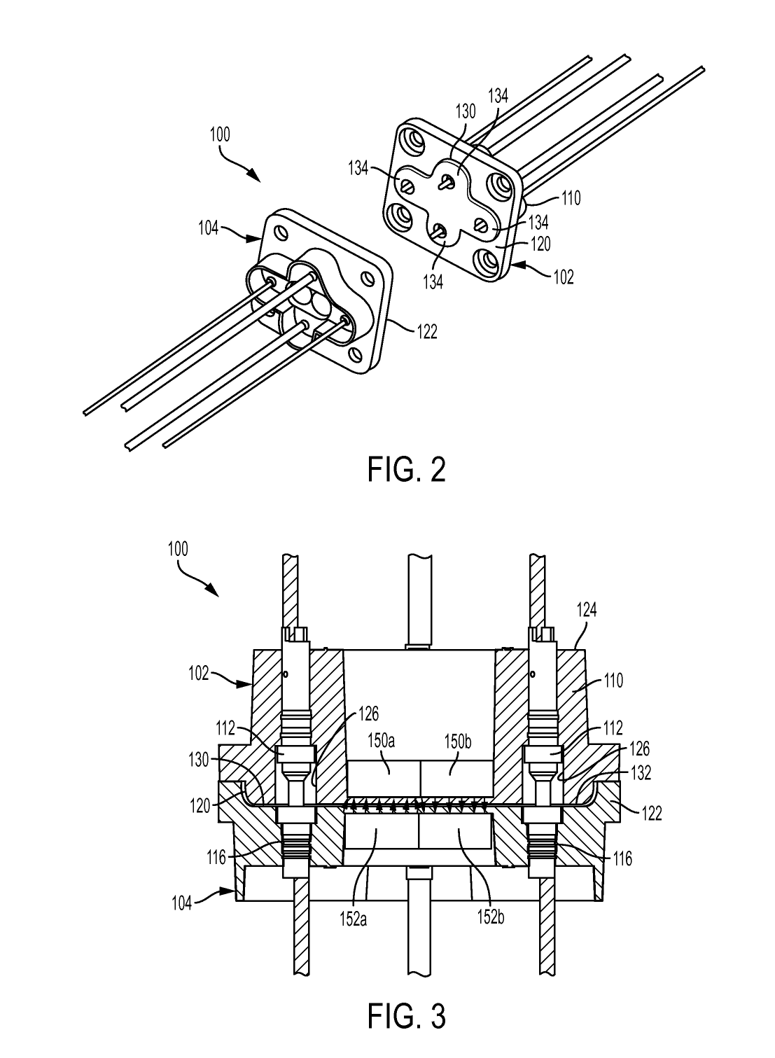

At the plug components' interface end 120 is an alignment member 130 that is designed to engage a corresponding alignment member 132 at the interface end 122 of the receptacle component 104. The alignment member 130 of the plug component 102 may be, for example, a protrusion, and the alignment member 132 of the receptacle component 104 may be, for example, a recess that is designed to receive the protrusion 130 only when the components 102 and 104 are properly oriented and mated. In a preferred embodiment, the alignment member 130 of the plug component is a shaped protrusion, such as a protrusion that has the shape generally of a cross, as seen in FIG. 2. The alignment member 132 of the receptacle component 104 is likewise preferably a shaped recess that generally matches the shape of the protrusion 130, such as a cross shape. Although a generally cross shape is preferred, the protrusion 130 and the recess 132 may have any shape. Although the plug component 102 is shown as having the shaped protrusion 130 and the receptacle component 104 is shown as having the shaped recess 132, the shaped protrusion 130 may be instead provided on the receptacle component 104 and the shaped recess 132 provided on the plug component 102.

The shaped protrusion 130 preferably includes a plurality of legs 134 where each leg 134 has an opening 136 that aligns and corresponds with a respective cavity 126 to receive an individual contact 112 therethrough. The shaped recess 132 similarly may include one or more legs 138 that each has an opening 140 for receiving a respective contact 116 of the receptacle component 104.

In addition to the alignment members 130 and 132, the present invention also provides magnets to ensure proper alignment and mating of the components. The magnets, when properly aligned, provide a dampening effect to retard vibration and shock (or other environmental factors) in the interface and will prevent signal discontinuity or interruption.

For example, a pair of magnets 150a and 150b may be disposed in the housing 110 of the plug component 102, preferably at its interface end 120. Another pair of magnets 152a and 152b may be disposed in the housing 114 of the receptacle component 104, preferably at its interface end 122. Each magnet 150a, 150b, 152a, 152b preferably has a disc shape; however the magnets 150a, 150b, 152a, 152b may have any shape as long as the magnets 150a, 150b, 152a, 152b can be accommodated at the interface ends 120 and 122 of the plug and receptacle component housings 110 and 114.

The polarization of each magnet 150a, 150b, 152a, 152b is selected such that the plug and receptacle components 102 and 104 attract one another when properly oriented for mating, as shown by the arrows in FIG. 3, and repel one another when not properly oriented for mating, as shown by the arrows in FIG. 4. Thus the magnets 150a, 150b, 152a, 152b facilitate proper mating of the plug and receptacle components 102 and 104, particularly in a blind-mate scenario or when dealing with small components. Also, the magnets 150a, 150b, 152a, 152b prevent improper mating of the plug and receptacle components 102 and 104 in similar situations.

In a preferred embodiment, the magnets 150a and 150b are centrally disposed in the shaped protrusion 130 of the plug component housing 110. The magnets 152a and 152b are likewise centrally disposed in the shaped recess 132 of the receptacle component housing 112. The magnets 150a and 150b are preferably positioned adjacent and touching one another in the plug component's housing 110 and the magnets 152a and 152b are preferably positioned adjacent and touching one another in the receptacle component's housing 114.

The magnet 150a of the plug component and the magnet 152a of the receptacle component 104 have opposite polarities. Similarly, the magnet 150b of the plug component 102 and the magnet 152b of the receptacle component 104 have opposite polarities. In addition, the polarities of the magnets 150a and 150b of the plug component 102 are opposite and the polarities of the magnets 152a and 152b of the receptacle component 104 are opposite. This selection of polarities ensures that the components 102 and 104 self-align for proper mating and repel to avoid improper mating. As seen in FIG. 2, the magnets 150a and 152a attract one another and the magnets 150b and 152b attract one another to secure the components 102 and 104 together. In that position, the pin contacts 112 are received in respective socket contacts 114 and the shaped protrusion 130 is received in the shaped recess 132. Even if one component is misaligned relative to the other component, for example if one component is rotated a certain number of degrees, such as 45 degrees, relative to the other component, the magnets will act to rotate and align the components for proper mating.

As seen in FIG. 4, if the components 102 and 104 are not properly aligned, the magnets 150a and 152b will repel one another and the magnets 150b and 152a will repel one another, thereby forcing the components apart. The operator need only rotate the components 102 and 104 relative to one another, and the magnets 150a, 150b, 152a, 152b will act to self-align them for proper mating. The magnets 150a, 150b, 152a, and 152b also stabilize the mating interface of the components to overcome any vibration and eliminate the possibility of openings or discontinuities during operation or signal transfer. If the connector is subjected to vibration during use, the magnets ensure that the mating components 102 and 104 do not disengage causing an open circuit in the axis of the magnets and the magnets reduce micro-motion in the plane perpendicular to the axis of the magnets. The reduction of micro-motion ensures that the mating contacts of the components 102 and 104 always stay properly aligned during use and reduces the occurrence of fretting corrosion due to excessive micro-motion and vibration. Thus the magnets provide alignment and latching of the components 102 and 104 in both the direction of the axis of the mated magnets and in a plane perpendicular to the axis of the mated magnets.

While a particular embodiment has been chosen to illustrate the invention, it will be understood by those skilled in the art that various changes and modifications can be made therein without departing from the scope of the invention as defined in the appended claims. For example, although each of the plug and receptacle components 102 and 104 is provided with a pair of magnets, one magnet may be provided in each component as long as those magnets have opposite polarities. Also, more than two magnets may be provided in each of the plug and receptacle components 102 and 104 as long as those magnets have the same opposite polarity pattern as described above.

1. An electrical connector assembly, comprising:
a first electrical component having a housing supporting at least one first contact, said housing including an interface end with a first alignment member;
a second electrical component configured to mate with said first electrical component, said second electrical component having a housing supporting at least one second contact configured to mate with said at least one first contact, said housing including an interface end with a second alignment member adapted to engage said first alignment member;
at least a first magnet centrally disposed at said interface end of said first electrical component, said first magnet having a first polarization; and
at least a second magnet centrally disposed at said interface end of said second electrical component, said second magnet having a second polarization that is the opposite of said first polarization,
wherein said first and second magnets attract one another to self-align said first and second electrical components such that said first and second alignment members are engaged with one another and said first and second contacts are mated with one another.

2. An electrical connector assembly according to claim 1, wherein
said first alignment member is a shaped protrusion.

3. An electrical connector assembly according to claim 2, wherein
said second alignment member is a shaped recess that has a shape that substantially matches the shape of said shaped protrusion.

4. An electrical connector assembly according to claim 3, wherein
each of said shaped protrusion and said shaped recess has substantially the shape of a cross.

5. An electrical connector assembly according to claim 4, wherein
at least one leg of said shaped protrusion receives said first contact; and
at least one leg of said shaped recess receives said second contact.

6. (canceled)

7. An electrical connector assembly according to claim 1, further comprising
a plurality of first contacts supported in said housing of said first electrical component; and
a plurality of second contacts supported in said housing of said second electrical component, each of said contacts of said plurality of second contacts is adapted to engage a respective contact of said plurality of first contacts.

8. An electrical connector assembly according to claim 1, wherein
said first and second magnets are discs.

9. An electrical connector assembly according to claim 1, wherein
said first and second magnets provide stabilization to the first and the second electrical components along a mating axis of said first and second magnets and in a plane perpendicular to said mating axis of said first and second magnets.

10. An electrical connector assembly, comprising:
a first electrical component having a housing supporting at least one first contact, said housing including an interface end with a first alignment member;
a second electrical component configured to mate with said first electrical component, said second electrical component having a housing supporting at least one second contact configured to mate with said at least one first contact, said housing including an interface end with a second alignment member adapted to engage said first alignment member;
a first magnet centrally disposed at said interface end of said first electrical component, said first magnet having a first polarization;
a second magnet centrally disposed at said interface end of said second electrical component, said second magnet having a second polarization that is the opposite of said first polarization;
a third magnet disposed adjacent said first magnet at said interface end of said first electrical component, said third magnet having a polarization that is the opposite of said first polarization; and
a fourth magnet disposed adjacent said second magnet at said interface end of said second electrical component, said fourth magnet having a polarization that is the opposite of said second polarization
wherein said first and second magnets attract one another and said third and fourth magnets attract one another to self-align said first and second electrical components such that said first and second alignment members are engaged with one another and said first and second contacts are mated with one another, and
wherein said first and third magnets repel one another and said second and fourth magnets repel one another to prevent engagement of said first and second contacts.

11. An electrical connector assembly according to claim 10, wherein
said first alignment member is a shaped protrusion.

12. An electrical connector assembly according to claim 11, wherein
said second alignment member is a shaped recess that has a shape that substantially matches the shaped of said shaped protrusion.

13. An electrical connector assembly according to claim 12, wherein
each of said shaped protrusion and said shaped recess has substantially the shape of a cross.

14. An electrical connector assembly according to claim 10, wherein
said first contact is a pin; and
said second contact is a socket.

15. An electrical connector assembly according to claim 10, further comprising
a plurality of first contacts supported in said housing of said first electrical component said plurality of first contacts are located outside of said first and third magnets; and
a plurality of second contacts support in said housing of said second electrical component, said plurality of second contacts are located outside of said second and fourth magnets, each of said contacts of said plurality of second contacts is adapted to engage a respective contact of said plurality of first contacts.

16. An electrical connector assembly according to claim 15, wherein
said first alignment member is a shaped protrusion with a plurality of legs, each of said plurality of first contacts extends through one of said plurality of legs; and
said second alignment member is a shaped recess with a plurality of legs corresponding to said plurality of legs of said shaped protrusion, each of said plurality of second contacts extends through one of said plurality of legs of said second alignment member.

17. An electrical connector assembly according to claim 16, wherein
said plurality of first contacts includes four first contacts; and
said plurality of second contacts includes four second contacts.

18. An electrical connector assembly according to claim 10, wherein
each of said first, second, third and fourth magnets is a disc.

19. (canceled)

20. An electrical connector assembly according to claim 10, wherein
said first and third magnets are touching one another; and
said second and fourth magnets are touching one another.

21. An electrical connector assembly according to claim 10, wherein
said first, second, third, and fourth magnets provide stabilization to the first and the second electrical components along a mating axis of said first and second magnets and in a plane perpendicular to said mating axis of said first and second magnets.

22. An electrical connector assembly according to claim 20, wherein
said first electrical component is a plug; and
said second electrical component is a receptacle.

23. An electrical connector assembly according to claim 3, wherein
said shaped protrusion has a rounded edge corresponding to a rounded edge of said shaped recess.

24. An electrical connector assembly according to claim 12, wherein
said shaped protrusion has a rounded edge corresponding to a rounded edge of said shaped recess.
